(19) United States
(12) Patent Application Publication
(10) Pub. No.: US 2015/0179025 A1
(43) Pub. Date: Jun. 25, 2015

(54) Modular privacy booth for cooperative use with teller station, ATM, or the like

(71) Applicant: Justin D. Cowell, Virginia Beach, VA (US)

(72) Inventor: Justin D. Cowell, Virginia Beach, VA (US)

(21) Appl. No.: 14/178,743

(22) Filed: Feb. 12, 2014

Related U.S. Application Data
(60) Provisional application No. 61/765,705, filed on Feb. 16, 2013.

(51) Int. Cl. G07F 19/00; E04F 11/00; E04H 1/06; E04H 1/12; E05G 7/00

(52) U.S. Cl. CPC G07F 19/2055; E04H 1/12; E05G 7/00; E04H 1/06; E04F 11/002

(57) ABSTRACT

A privacy booth for isolating a user from the surrounding environment so as to provide acoustical and possibly visual privacy to the user. A single privacy booth may be utilized when a user must interact with an electronic device or terminal, for example, an ATM. When interacting with a human, for example, a bank teller, a pair of joined privacy booths provide acoustical and visual privacy to both interacting parties. The solid but possibly transparent barrier between the user and the teller helps prevent “snatch and grab” type crimes and protects the teller from armed robbery attempts. Access to the user's privacy booth may be controlled using access keypads that open semi-circular doors. A transaction pass-through tube allows for passing paper documents back and forth between the user and the teller. The privacy booth may have an elevateable floor and a ramp allowing access to wheel chair confined persons.

### RELATED APPLICATIONS

This application claims priority to U.S. Provisional Patent Application No. 61/765,705 for Sound Proof Privacy Booth filed Feb. 16, 2013 that is included herein in its entirety by reference.

### FIELD OF THE INVENTION

The invention pertains to privacy booths and more particularly, to privacy booths associated with transaction terminals or customer service windows.

### BACKGROUND OF THE INVENTION

Identity theft continues to be one of the fastest growing crimes in the United States. It is important for consumers to recognize that identity theft is not just a financial crime. This crime varies widely, and can include financial identity theft (checking and/or credit card fraud), criminal identity theft, governmental identity theft, and medical identity theft. The Identity Theft Resource Center® (ITRC www.identitytheftcenter.org) is a nonprofit, nationally respected organization dedicated exclusively to the understanding of identity theft and related issues. The ITRC provides victim and consumer support as well as public education. The ITRC also advises governmental agencies, legislators, law enforcement, and businesses about the evolving and growing problem of identity theft.

When personal and/or financial information is publically disclosed, for example at the teller window of a bank, credit union, medical facility, or numerous other similar places, there is generally some risk that all or part of that information may be compromised (i.e., “stolen”) by a person not authorized to have access to that information. When information is entered into a public computer terminal or apparatus, for example, an Automated Teller Machine (ATM), there is still a risk of personal information such as a Personal Identification Number (PIN) being observed by an unauthorized person. Further, a financial transaction at a teller window may be compromised when a teller innocently asks a customer making cash withdrawal a question such as “how would you like the money, in one-hundreds, fifties, twenties, etc.” Such information may alert an observer to the fact that the customer will soon be carrying a possible substantial amount of cash.

In medical facilities, for example doctor's offices, hospital emergency room registration desks, pharmacies, or the like, personal information divulged by a client may be overheard. Also other situations such as general conversation with a teller/customer service rep. can lead to questions and or answers about a current or previous account disclosing sensitive information that could possibly lead to fraud and or Identification theft. When “you the customer/consumer” walk into a business such as a bank or hospital “you should feel safe and trustworthy of that facility disclosing sensitive and confidential information” Knowing that your transactions are strictly between the teller and the customer and not an unwanted third party. Also that the teller and or customer service rep. should feel safe into arriving into work everyday knowing that their protected by such product and not worrying about the threat of arm robbery or being shot at because of someone who just wants money.

In many facilities, a queue of waiting customers or patients are requested to stay an appropriate distance away from a window, counter, etc. where another person is conducting a transaction. Even with this precaution, it is still possible for a person in the queue to overhear some portion of the transaction.

### DISCUSSION OF THE RELATED ART

The prior art shows several proposed solutions for limiting or eliminating the loss of sensitive information disclosed by a patient or customer at a teller window and vise versa, a medical intake desk, an ATM, or any other facility where a user is required to divulge sensitive information.

For example, U.S. Pat. No. 6,241,151 for SELF SERVICE TERMINAL issued Jun. 5, 2001 to Stephen Swaine et al. teaches a self service terminal (SST) that has a front portion including a user interface located within a fascia. The fascia has a concave inner surface that defines a privacy area and which reduces reflection of sound. The inner surface is bounded by one or more extremities which project out from the terminal. The fascia has a canopy that extends beyond the projecting extremities. In use, the user places his head within or in proximity to the privacy area for increased privacy when using the terminal.

U.S. Pat. No. 4,773,338 for TRANSACTION SECURITY SYSTEM AND MODULAR TRANSACTION PROCESSING CENTER issued Sep. 27, 1988 to Hastings, discloses a transaction security device consisting of a booth of a material and construction capable of selective voluntary entry and involuntary personnel retention and incorporating a transaction interface; entrance means for said booth; a closure for said entrance means, and control means adapted to secure and unsecure at least said entrance means; and cooperating with said booth, disposed, therein, or indeed independent thereof, at least one secondary enclosure adapted to contain apparatus disposed upon at least one turntable within a housing module composed of an enclosure, portions of which are independently rotatable about said turntable and the devices disposed thereon; and means for access to the interior of said housing and with said transaction interface.

U.S. Pat. No. 4,813,475 for TEMPERATURE CONTROL MEANS FOR A SELF SERVICE BANKING SYSTEM issued Mar. 21, 1989 to Edward F. Couvrette provides a self service banking system including a walk-in kiosk housing an Automatic Teller Machine (ATM). The kiosk includes a pivotable interior access door on one end thereof which is pivotable between open and closed positions and a side wall rotatable quarter panel expansion area for allowing access to the interior of the ATM. The kiosk provides a secure enclosed environment for the automatic teller machine (ATM) and its contents. An air distribution system, a laminated wall insulation, heating and cooling systems and their controls are provided to maintain the interior temperature and humidity of the kiosk within the normal temperature and humidity operational range of the computer of the ATM during exposure of the kiosk to a wide range of ambient temperatures and humidity beyond the acceptable operating temperature and humidity range of the ATM and its computers.

U.S. Pat. No. 4,821,118 for VIDEO IMAGE SYSTEM FOR PERSONAL IDENTIFICATION issued Apr. 11, 1989 to Roget F. Lafreniere teaches a video image system for rapidly (in a few seconds) recording a person and his identification (ID) card makes video images of the person's hand palm and face along with the ID card presented by the person that may be a badge, card, drivers license, passport, or other item issued by some authority, and combines those images and presents the combined image on a video monitor for immediate inspection by a guard, store clerk or attendant, and, in addition, stores the combined image along with time and date superimposed thereon so that it can be reviewed later. The system includes at a designated place entered by the person to be recorded, a viewing table in easy reach of the person on which there are viewing areas for the person's palm and the ID card that he presents and video cameras arranged for scanning his palm, ID card and his face producing video images that are combined electronically producing a combined video image of the palm. An ID card and face may be viewed on a video monitor and recorded on a video cassette recorder (VCR) along with the time and date. The combined image that is recorded can be reviewed later as a review of the identification event.

None of the patents and published patent applications, taken singly, or in any combination are seen to teach or suggest the novel Modular Privacy Booth for Cooperative Use with a Teller Station, ATM, or the Like of the present invention.

### SUMMARY OF THE INVENTION

In accordance with the present invention there is provided a privacy booth for isolating a user from the surrounding environment so as to provide acoustical and, visual privacy to the user. A single privacy booth may be utilized when a user must interact with an electronic device or terminal, for example, an ATM. When interaction with a human, for example, a bank teller, a pair of joined privacy booths provide acoustical and visual privacy to both interacting parties. The solid but possibly transparent barrier between the user and the teller helps prevent “snatch and grab” type crimes and protects the teller from armed robbery attempts and or gun fire.

Access to the user's privacy booth is controlled using an access keypad. The access keypad may incorporate one or several devices such as a keyboard/keypad, a magnetic strip card reader, an OCR bar code reader, a Quick Response (QR) code optical reader, and a biometric scanner, for example, a fingerprint scanner to protect against the misuse of (OCR). As far as criminals/Docket thieves installing credit card readers to obtain customers transaction/personal information including funds from account.

Semi-circular doors open when a user enters an acceptable entry code or presents acceptable media.

A transaction pass-through box or tube allows the passing of paper documents back and forth between the user and the teller. That opens only on customer side as per customer's request to teller. Money, receipt, bank slips are placed inside and when hands and arms are removed from inside tube, door then closes and starts back scattering x ray process to detect any danger of harmful materials or weapons before teller thinks its safe to open only on teller's request.

When the transaction(s) are complete, the user causes the door to reopen only on teller's command, controlled by an airlocking system for security purposes, and exits the privacy booth.

Optionally, the privacy booth may be equipped with a electronic floor raising mechanism and a ramp that allows a disabled user in a wheel chair or similar conveyance to remain seated while being elevated to an equivalent height of a standing user for a comfortable and professional like transaction, catered to the handicapped/disabled and even undersized persons.

It is, therefore, an object of the invention to provide a privacy booth to enclose a user to provide acoustical and visual privacy to the user when he or she is divulging sensitive private information.

It is another object of the invention to provide a privacy booth to enclose a user that is substantially circular and has semi-circular doors that selectively open and close.

It is an additional object of the invention to provide a privacy booth to enclose a user that incorporates an entry keypad to allow only authorized users to open the door and enter the privacy booth, with non banking members able to obtain a temporary access by visiting customer service side to still be able to access booth on a one day visitors pass by providing customer service with proper I.D and personal information for security purposes.

It is a further object of the invention to provide a privacy booth connected to a second privacy booth, the first privacy booth enclosing a user thereby allowing the user to divulge sensitive personal information to a teller in the second privacy booth.

It is a still further object of the invention to provide a privacy booth to enclose a user having a transaction pass-through box for bidirectionally transferring paper documents, cash, or other physical items between the user and the teller.

It is yet another object of the invention to provide a privacy booth to enclose a user wherein a teller in the second privacy booth may activate an alarm when the need arises.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1A is a simplified front perspective, schematic view of a view of a first embodiment of a privacy booth in accordance with the invention;

FIG. 1B is a simplified front perspective, schematic view of a view of the privacy booth of FIG. 1 but having a raiseable floor;

FIG. 2 is a simplified front elevational, schematic view of the privacy booth of FIG. 1A;

FIG. 3 is a top plan schematic view of the privacy booth of FIG. 2;

FIG. 4 is a top plan, schematic view of a single privacy booth with a user interacting with an ATM or the like;

FIG. 5 is a top plan, schematic view of a pair of privacy booths connected one to another in accordance with the invention;

FIG. 6 is an architectural rendering, front perspective view of four privacy booths in a typical operating environment; and

FIG. 7 is a perspective view of a typical teller station utilizing a privacy booth.

### DETAILED DESCRIPTION OF THE PREFERRED EMBODIMENT

The present invention provides modular privacy booths for cooperative use with a teller station, ATM, or the like. The novel privacy booth may be used in applications where a customer, client or other person may securely reveal sensitive personal data or information while minimizing the risk of inadvertently sharing such data or information with a person unauthorized to receive such information. As used hereinafter, the term user is intended to represent any client, patient, or other such person in need of privacy to conduct a transaction.

The novel privacy booth may be used individually, for example, to protect the privacy of an ATM or other similar electronic work station. When two of the privacy booths are interconnected back-to-back for applications such as teller stations, etc., the privacy of both the user and the teller are protected.

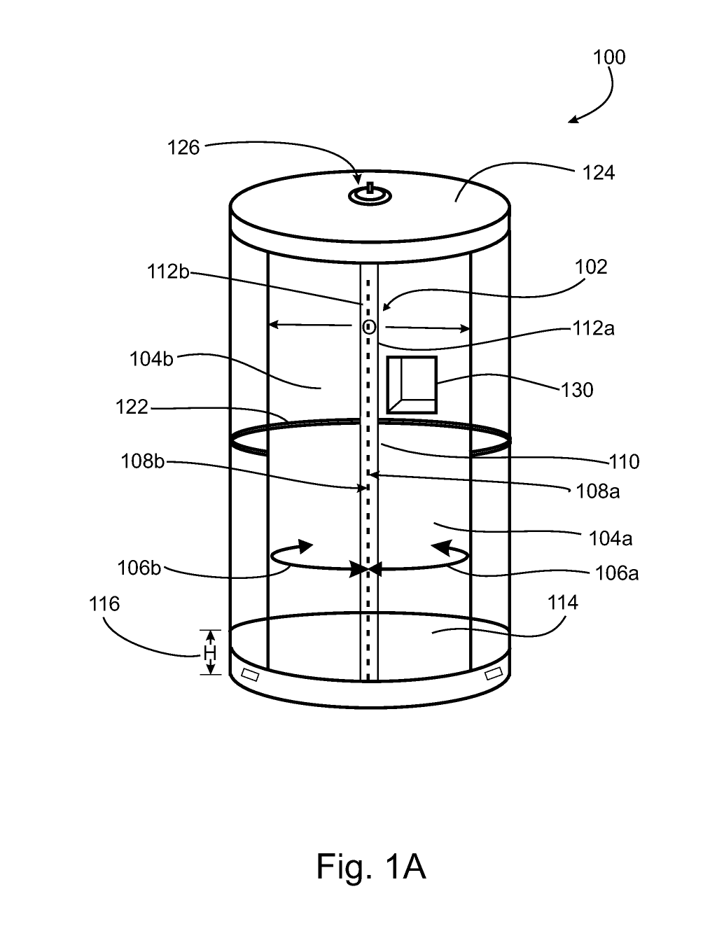

Referring first to FIG. 1A, there is shown a simplified front perspective, schematic view of a first embodiment of a privacy booth in accordance with the invention, generally at reference number 100.

Privacy booth 100 is structure having arcuate upstanding walls, typically forming a substantially a cylindrical structure. It will be recognized that privacy booths in accordance with the invention may be constructed with arcuate upstanding walls to form structures other than circular structures. In still other embodiment, privacy booths may be constructed with a mix or arcuate and non-arcuate upstanding walls. In additional embodiments, privacy structure may be constructed with nothing but non-arcuate upstanding walls. Consequently, privacy booths having a wide variety of cross sectional shapes may be constructed. Therefore, the invention is not considered limited to a particular cross sectional shape. Rather the invention includes privacy booths having any cross-sectional shape.

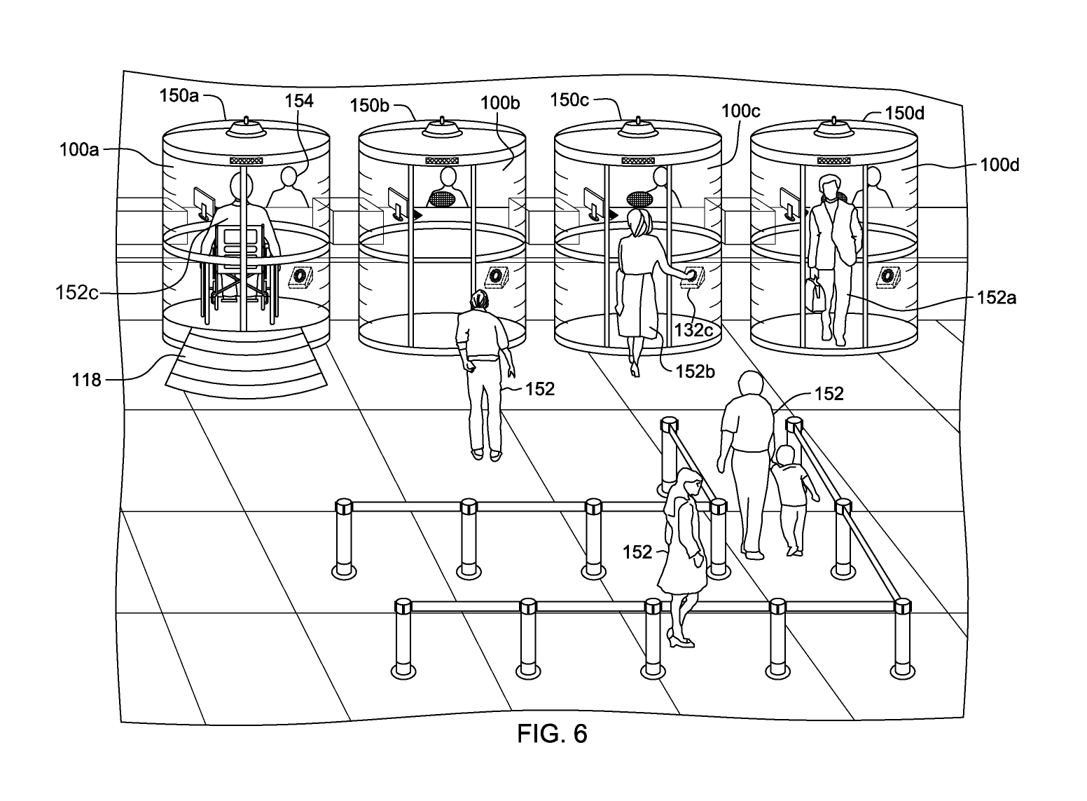

An opening “O” 102 extends across a front facing region of privacy booth 100. Opening 102 is sized to accommodate a wheelchair, power chair, or other conveyance suitable for use by a handicapped person 152c, best seen in FIG. 6, to enter privacy booth 100 to transact private business.

Opening 102 may selectively be closed by a sliding door, typically implemented as a pair of sliding doors 104a, 104b that selectively open and close in directions shown by respective arrows 106a, 106b. In a closed position, outer edges 108a, 108b of respective sliding doors 104a, 104b meet at a central point 110, their outer edges abutting one to the other. When necessary, seals 112a, 112b may be applied to respective door outer edges 108a, 108b to improve acoustical privacy by limiting the amount of sound emanating from within privacy booth 100 to an external space, not specifically identified.

A door opening apparatus, not shown, is operatively connected to sliding doors 104a, 104b to perform door opening and door closing function upon command. Such door opening and closing mechanisms are believed to be well known to those of skill in the art and, consequently, are not further described or discussed herein.

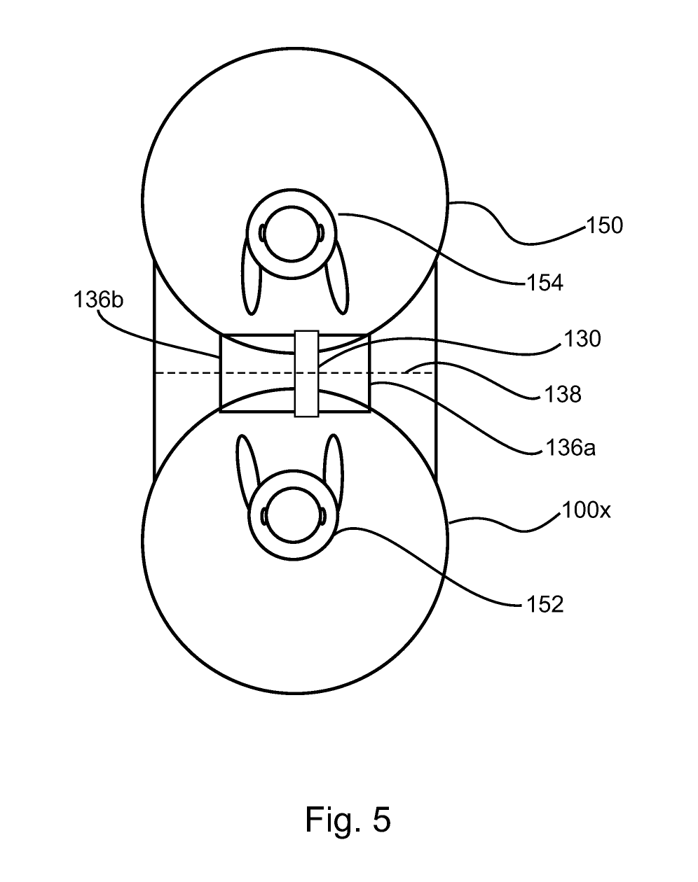

An optional transaction pass-through box 130 connects the interior of privacy booth 100 to a space directly behind the booth, typically a contiguous connected second privacy booth 150, best seen in FIG. 5. When implemented, the distal end of transaction pass-through box 130 terminates in second privacy booth 150.

In privacy booth 100, a floor 114 is typically raised as small distance “H” 116 above the level of a surface, not specifically identified, upon which privacy booth 100 is supported.

A handrail 122 encircles the entire interior surface of privacy booth 100.

A top of dome 124 completely seals the interior of privacy booth 100. A signal assembly 126, discussed in more detail hereinbelow is affixed atop dome 124, typically proximate an apex, not specifically identified, of dome 124. It will be recognized that structures, not shown, other than domes 124 may be used to seal the upper portion of privacy booth 100.

Referring now also to FIG. 1B, there is shown a simplified front perspective, schematic view of a second embodiment of a privacy booth 100, generally at reference number 100′.

Privacy booth 100′ has all the previously described features and structures but in addition has an elevateable floor 114′ that raises a person seated in a wheel chair, scooter, or other such conveyance to a height whereat they may utilize privacy booth 100′ in an equivalent manner to a standing person of average height. Floor 114′ is raised by a floor elevating mechanism, not shown in FIG. 1B, that may include motor driven scissor jacks, not shown, one or more hydraulic cylinders, not shown, or any other suitable similar lift system components. It will be recognized that a control system, not shown, incorporating at least necessary controls and limit switches, none shown, would form a part of any floor elevating system. If hydraulic cylinders are used to raise floor 114′, support pumps, tanks, valves, etc., none shown, all known to those of skill in the hydraulic arts, are required for cooperative uses with one or more hydraulic cylinders.

A ramp 118, typically having a non-slip surface treatment 120 applied to an upper major surface thereof allows safe ingress and egress to privacy booth 100′ by both non-handicapped persons 152a, 152b and handicapped persons 152c, respectively, all best seen in FIG. 6. In alternate embodiments, ramp 118 may be retracted into a lower portion of privacy booth 100′. Ramp 118 is sized and configured so that an upper edge meets and mates with floor 114′ when floor 114′ is in a raised disposition.

Note that privacy booth 100 and 100′ are typically sized to accommodate two adult persons inside, including one adult person in a wheel chair or similar conveyance.

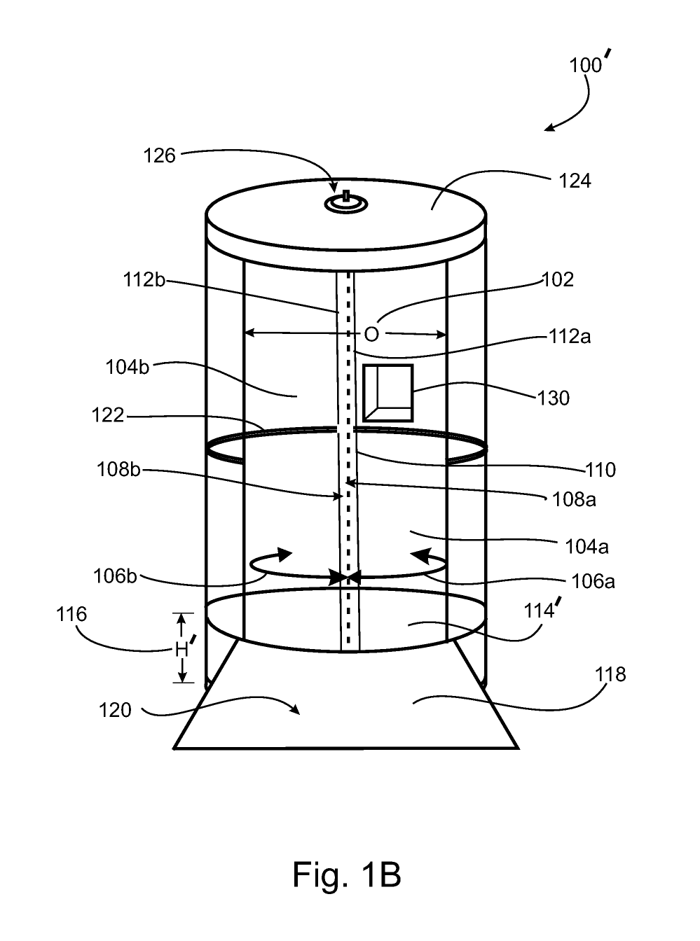

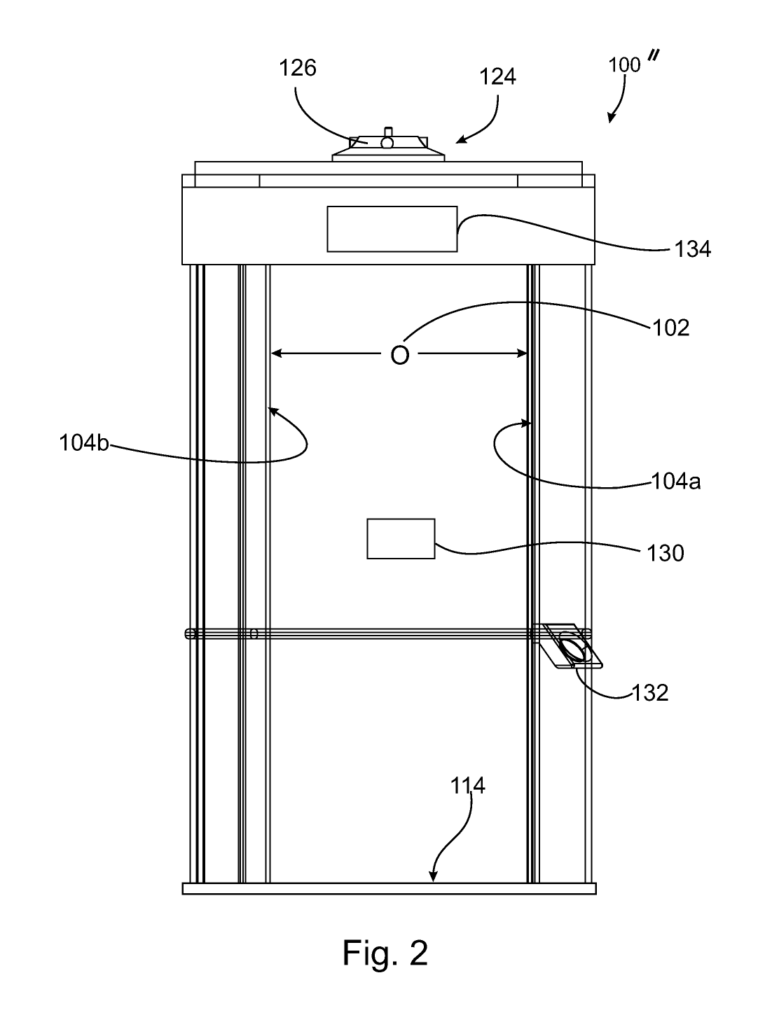

Referring now also to FIGS. 2 and 3, there are shown simplified front elevational, and top plan schematic views, respectively of the privacy booth similar to privacy booth 100 of FIG. 1A and of the privacy booth 100′ of FIG. 1B, generally at reference number 100″.

Additional features not shown in FIGS. 1A and 1B include an access “keypad” 132 and an external speaker 134. The term “access keypad” is used to refer to devices that may include keypads, biometric scanners, magnetic card readers, RFID devices, OCR card readers, and any other access control devices.

External speaker 134 may be utilized in a number of ways but generally is connected as part of an intercom system, not shown. External speaker may, in some installations, be designated for emergency use but not limited to soft music being played while customer utilizes booth, for both entertainment and or to help reduce listening in on transactions inside booth.

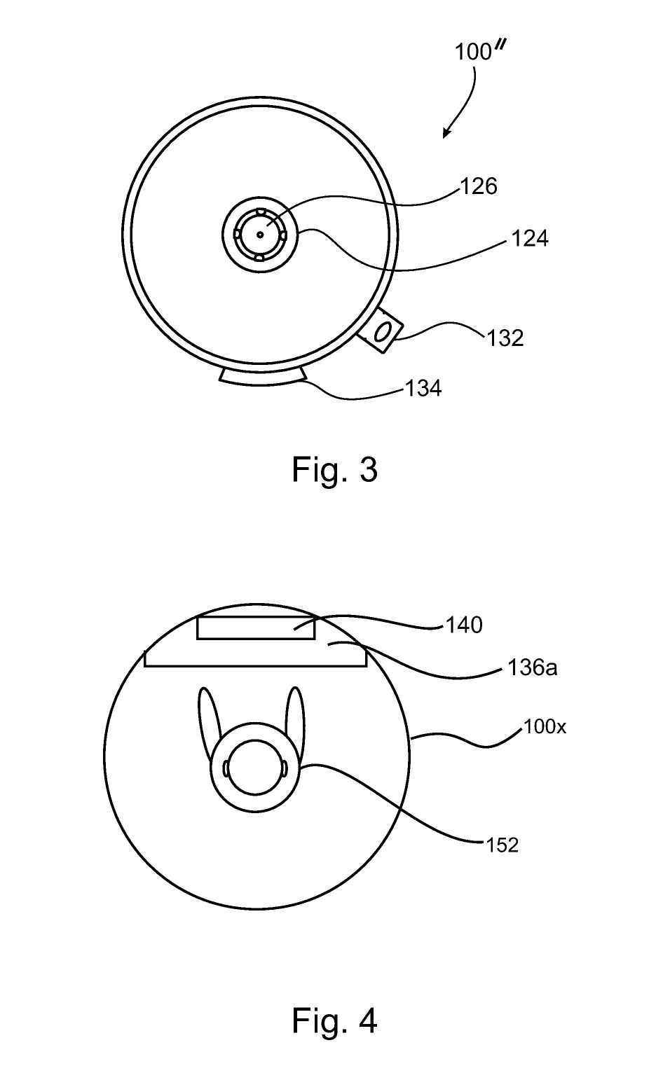

Referring now also to FIG. 4, there is shown a top plan, schematic view of a single privacy booth 100x selected from privacy booths 100, 100′, or 100″. A single privacy booth 100x is useful in applications wherein a user interacts with an ATM or other electronic device or system and wherein the user needs to maintain privacy while disclosing sensitive personal information.

A user 152 is shown interacting with an ATM or the like 140. A work surface or shelf 136a is provided for the convenience of user 152. All of the other features previously discussed may readily be incorporated into privacy booth 100x.

Referring now also to FIG. 5, there is shown a top plan, schematic view of a first privacy booth 100x selected from privacy booths 100, 100′, or 100″ connected to a second privacy booth 150. Privacy booth 100x is configured for occupancy and use by a user. Privacy booth 150 is adapted for occupancy and use by a teller or the like. The internal details of privacy booth 150 are discussed in more detail hereinbelow.

A barrier 138 separates the internal regions of privacy booths 100x and 150. Barrier 138 may optionally be completely or partially transparent to facilitate visual communication between privacy booth 100x and 150. It is assumed that barrier 138 may be made from a bullet proof material to provide security primarily to teller 154.

Privacy booths 100x and 150 are typically joined by transaction pass-through tube 130 sized and configure to allow two-way movement of paper documents, bills, and coins.

A schematic representation of a user 152 is shown within privacy booth 100x. A schematic representation of a teller or other similar person 154 is shown within privacy booth 150. It will be recognized that neither user 152 nor teller 154 form any part of the invention but are shown to illustrate the intended function of the privacy booths of the invention.

Referring now also to FIG. 6, there is shown an architectural rendering of four privacy booths 100a . . . 100d in a typical operating environment. Privacy booths 100a, 100b, 100c, 100d are disposed adjacent one another in a customer lobby, not specifically identified, of a bank or similar institution that forms no part of the invention. A single handicap access booth 100a is a booth 100′ as seen in FIG. 1B. Three “conventional” privacy booths 100 as seen in FIG. 1A and designated 100b, 100c, 100d are disposed adjacent thereto.

Customers (i.e., users) 152, 152a, 152b and 152c are shown in various stages of use of privacy booths 100a . . . 100d. Customers 152 are waiting in a queue for a chance to conduct business in one of privacy booths 100a . . . 100d.

Customer 152a is exiting privacy booth 100d, presumably having completed his or her business therewithin.

Customer 152b is utilizing access keypad 132c to allow entry into privacy booth 100c.

Customer 152c, seated in a wheelchair or similar conveyance, not specifically identified, within privacy booth 100a, presumably in the process of conducting his or her business therein.

Attached to each of privacy booth 100a . . . 100d is an attached corresponding teller booth 150a . . . 150d. As best seen in teller booth 150a, a teller 154 is transacting business.

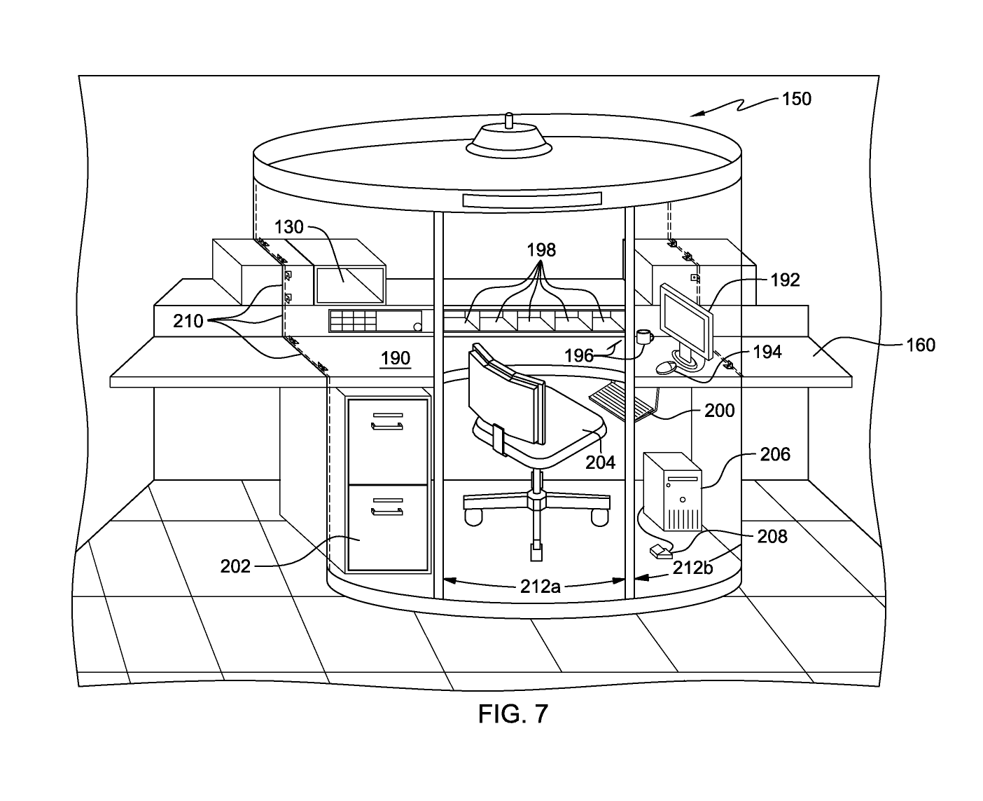

Referring now also to FIG. 7, there is shown a rear perspective, schematic view of a teller station 160 disposed in a teller booth 150.

A wall 210 of teller station 150 may be constructed to conform and seal to an existing teller station 160. Sliding doors 212a, 212b and shown in a closed position. A teller 156, not seen in FIG. 7 for sake of clarity, working within privacy booth 150 would be acoustically isolated from the space surrounding privacy booth 150.

The teller end of transaction pass-through box 130 is shown.

Teller station “components”, none of which form any part of the present invention are shown. A work surface 190 typically supports a computer monitor 192 and computer pointing device (mouse) 194. Personal objects 196, typified by a coffee cup and a pen) are also disposed on work surface 190. As series of “pigeon hole” compartments 198 are provided for storing paper forms, none shown, used for transacting business,

A computer keyboard 200 is suspended beneath work surface 190. A file cabinet 202, a chair 204, and computer 206 are disposed on the floor, not specifically identified, beneath work surface 190 within teller workstation 160.

A “silent alarm” foot switch 208 may be provided. Foot switch 208 may be utilized in a number of ways believed to be well known to those of skill in the security arts. Consequently, the use of foot switch 208 forms no part of the present invention.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A privacy booth, comprising:
a) an enclosure having an arcuate wall having a lower edge, an upper edge, a height, and an opening having a width therein;
b) a sliding door selectively movable between an open position and a closed position disposed in said opening, when said sliding door is in said closed position, said opening is completely closed;
c) a floor attached to said arcuate wall at said lower edge thereof, and
d) a top attached to said arcuate wall at said upper edge thereof.

2. The privacy booth as recited in claim 1, wherein said arcuate wall comprises a wall chosen from the group: a circular wall, an oval wall, and a semicircular wall.

3. The privacy booth as recited in claim 1, wherein said height is selected to accommodate a standing adult human user within said privacy booth.

4. The privacy booth as recited in claim 1, wherein said opening has a width sufficient to allow passage of an adult human in a wheel chair.

5. The privacy booth as recited in claim 4, wherein said sliding door comprises a pair of sliding door sections, each of said pair of sliding door sections having an outer edge adapted and configured to abut and seal to the other of said sliding door sections when said sliding door is in said closed position, each of said sliding door sections moving away from each other until said sliding door is in said open position.

6. The privacy booth as recited in claim 1, wherein said top comprises a dome-shaped top comprising a signal assembly disposed on an external surface thereof proximate an apex of said dome-shaped top.

7. The privacy booth as recited in claim 1, further comprising:
e) a floor elevating mechanism operatively connected to said floor for selectively raising and lowering said floor; and
f) a ramp disposed external to said privacy booth and having a outer edge substantially flush with a floor upon which said privacy booth is disposed and an inner edge connected to said privacy booth at said opening at a height of said floor, said ramp having a width at least as great as said width of said opening.

8. The privacy booth as recited in claim 1, further comprising:
e) an access control mechanism operatively connected to said sliding door; and
f) an access control panel disposed externally to said privacy booth and operatively connected to said access control mechanism; whereby a user wishing to open said sliding door must enter a recognized access code at said access control panel, said sliding door automatically opening upon entry of said authorized access code.

9. The privacy booth as recited in claim 8, wherein said access control panel comprises at least one mechanism chosen from the group: a keyboard, a keypad, a magnetic strip card reader, an OCR bar code reader, a Quick Response (QR) code optical reader, and a biometric scanner.

10. The privacy booth as recited in claim 9, wherein said biometric scanner comprises a fingerprint scanner.

11. A privacy booth system, comprising:
a) a pair of contiguous enclosures connected one to the other, each having an arcuate wall having a lower edge, an upper edge, a height, and an opening having a width therein;
b) a sliding door disposed in at least one of said pair of enclosures, said sliding door being selectively movable between an open position and a closed position disposed in said opening, when said sliding door is in said closed position, said opening is completely closed;
c) a floor disposed in each of said enclosures, each floor being attached to a respective one of said arcuate walls at said lower edge thereof, and
d) a top disposed in each of said enclosures, each top being attached to respective one of said arcuate walls at said upper edge thereof; e) a transaction pass through device communicative with each of said two enclosures.

12. The privacy booth system as recited in claim 11, wherein said arcuate wall of at least one of said pair of enclosures comprises a wall chosen from the group: a circular wall, an oval wall, and a semi-circular wall.

13. The privacy booth system as recited in claim 11, wherein said sliding door of at least one of said pair of enclosures comprises a pair of sliding door sections, each of said pair of sliding door sections having an outer edge adapted and configured to abut and seal to the other of said sliding door sections when said sliding door is in said closed position, each of said sliding door sections moving away from each other until said sliding door is in said open position.

14. The privacy booth system as recited in claim 11, further comprising:
e) a floor elevating mechanism operatively connected to said floor for selectively raising and lowering said floor of at least one of said pair of enclosures; and
f) a ramp disposed external to said privacy booth and having a outer edge substantially flush with a floor upon which said privacy booth is disposed and an inner edge connected to said privacy booth at said opening at a height of said floor of said at least one of said pair of enclosures, said ramp having a width at least as great as said width of said opening of said at least one of said pair of enclosures.

15. The privacy booth system as recited in claim 11, further comprising:
e) in at least one of said pair of enclosures, an access control mechanism operatively connected to said sliding door; and
f) an access control panel disposed externally to said at least one of said pair of enclosures, and operatively connected to said access control mechanism.

16. A privacy booth system as recited in claim 11, wherein a first of said pair on enclosures comprises a user compartment and a second of said two enclosures comprises a teller compartment.

17. A privacy booth system as recited in claim 11, further comprising:
f) a communication system operatively connected to each of said pair of enclosures allowing an occupant of each of said pair of enclosures to have at least two-way voice communication with one another.
